(19) United States
(12) Patent Application Publication
(10) Pub. No.: US 2016/0378778 A1
(43) Pub. Date: Dec. 29, 2016

(54) PRESENTATION DEVICE, PRESENTATION METHOD AND STORAGE MEDIUM

(71) Applicant: CASIO COMPUTER CO, LTD., Tokyo (JP)

(72) Inventor: Toshihiko Otsuka, Tokyo (JP)

(21) Appl. No.: 15/188,465

(22) Filed: Jun. 21, 2016

(30) Foreign Application Priority Data
Jun. 24, 2015 (JP) 2015-126738

(51) Int. Cl. G06F 17/30; G06Q 10/10

(52) U.S. Cl. CPC G06F 17/3097; G06F 17/30241; G06Q 10/1093

(57) ABSTRACT

A map display device includes an itinerary plan definition unit, a gear reading unit, and an output unit. The itinerary plan definition unit defines a course. The gear reading unit identifies gear considered necessary when following the course, based on the information on the course defined by the itinerary plan definition unit. The output unit presents the gear considered necessary when following the course, identified by the gear reading unit. As a result, the map display device can automatically present gear which is appropriate to a planned course.

This application is based upon and claims the benefit of priority from the prior Japanese Patent Application No. 2015-126738, filed Jun. 24, 2015, and the entire contents of which are incorporated herein by reference.

### BACKGROUND OF THE INVENTION

Field of the Invention

The present invention relates to a presentation device, a presentation method, and a storage medium.

Related Art

A technique of allowing a user to select gear required for travel, mountaineering, etc. and presenting a note for reminding the user on the scheduled day has conventionally been known (Japanese Unexamined Patent Application Publication No. 2015-018545).

### SUMMARY OF THE INVENTION

However, the technique disclosed in Japanese Unexamined Patent Application Publication No. 2015-018545 only allows the user to manually select gear based on a plan of travel etc. and selection of the gear depends on the user's experience, leading to a lack of gear or carrying of unnecessary gear.

The present invention has been made in view of such a situation, and has an object of automatically presenting gear which is appropriate to a planned itinerary.

In order to achieve the above-mentioned object, the presentation device according to an aspect of the present invention includes:

A presentation control method for a presentation device including a control unit, wherein the control unit:

identifies information on gear considered necessary for a user to carry when following a route, based on information on the route that the user will follow; and

outputs the information identified on the gear to an external output unit to present to the user.

According to the present invention, it is possible to automatically present gear which is appropriate to a planned itinerary.

### BRIEF DESCRIPTION OF THE DRAWINGS

FIG. 1 is a block diagram showing the hardware configuration of a map display device according to an embodiment of a presentation device of the present invention;

FIG. 2 is a functional block diagram showing the functional configuration for executing a gear list display processing, among the functional configurations of the map display device shown in FIG. 1;

FIGS. 3A-3C are a schematic view for illustrating information relating to the gear list to be presented; and

FIG. 4 is a flowchart illustrating the flow of the gear list display processing executed by the map display device of FIG. 1 having the functional configuration of FIG. 2.

### DETAILED DESCRIPTION OF THE INVENTION

Hereinafter, embodiments of the present invention will be explained while referencing the drawings.

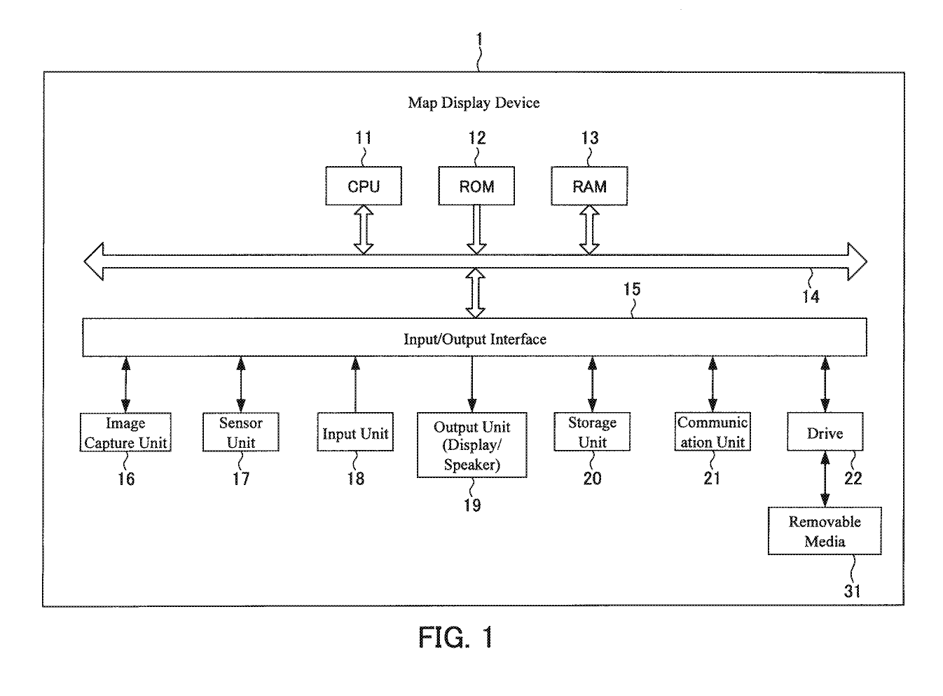

FIG. 1 is a block diagram showing the hardware configuration of a map display device according to an embodiment of a presentation device of the present invention.

The map display device 1 is configured as a smartphone, for example.

The map display device 1 includes a CPU (Central Processing Unit) 11, ROM (Read Only Memory) 12, RAM (Random Access Memory) 13, a bus 14, an input/output interface 15, an image capture unit 16, an input unit 18, an output unit 19, a storage unit 20, a communication unit 21, and a drive 22.

The CPU 11 executes various processes in accordance with a program stored in the ROM 12 or a program loaded from the storage unit 20 to the RAM 13.

Data, etc. required upon the CPU 11 executing the various processing is stored in the RAM 13 as appropriate.

The CPU 11, ROM 12 and RAM 13 are connected to each other via the bus 14. In addition, the input/output interface 15 is also connected to this bus 14. The imaging unit 16, sensor unit 17, input unit 18, output unit 19, storage unit 20, communication unit 21 and drive 22 are connected to the input/output interface 15.

The image capture unit 16 includes an optical lens unit and an image sensor, which are not shown.

In order to photograph an object, the optical lens unit is configured by a lens such as a focus lens and a zoom lens for condensing light.

The focus lens is a lens for forming an image of an object on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of an object in the optoelectronic conversion device. The optoelectronic conversion device optoelectronically converts (i.e. captures) the image of the object, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 16.

Such an output signal of the image capture unit 16 is hereinafter referred to as “data of a captured image”. Data of a captured image is supplied to the CPU 11, an image processing unit (not illustrated), and the like as appropriate.

The sensor unit 17 is composed of a GPS (Global Positioning System) reception module, a hexaxial acceleration sensor, a gyro sensor, a barometric pressure sensor, etc. and performs various sensing to acquire sensor information such as positional information, device posture information, environmental information of surroundings of the device.

The input unit 18 is configured by various buttons and the like, and inputs a variety of information in accordance with instruction operations by the user.

The output unit 19 is configured by a display (display unit), a speaker, etc., and outputs images and sound. The display can be, for example, an LCD (Liquid Crystal Display), etc.

The storage unit 20 is configured by DRAM (Dynamic Random Access Memory) or the like, and stores data of various images.

The communication unit 21 controls communication to be performed with another device (not illustrated) via a network including the Internet. In addition, the communication unit 21 is configured to be capable to communicate in conformity to short-range communication standards such as Wi-Fi, ZigBee, BLE (Bluetooth (registered trademark) Low Energy) etc.

A removable medium 31 composed of a magnetic disk, an optical disk, a magneto-optical disk, semiconductor memory or the like is installed in the drive 22, as appropriate. A program read from the removable media 31 by the drive 22 is installed in the storage unit 20 as necessary. In addition, similarly to the storage unit 20, the removable media 31 can store various data such as the data of images stored in the storage unit 20.

The map display device 1 thus configured has a function of displaying current location on map information. In addition to the function, the map display device 1 has a function of allowing a user to define an itinerary plan (for example, a mountaineering plan) composed of course (route) and schedule in advance and displaying to present to the user a list of gear such as equipment and foodstuff required to finish an itinerary (gear considered necessary when following the itinerary) based on the itinerary plan thus defined.

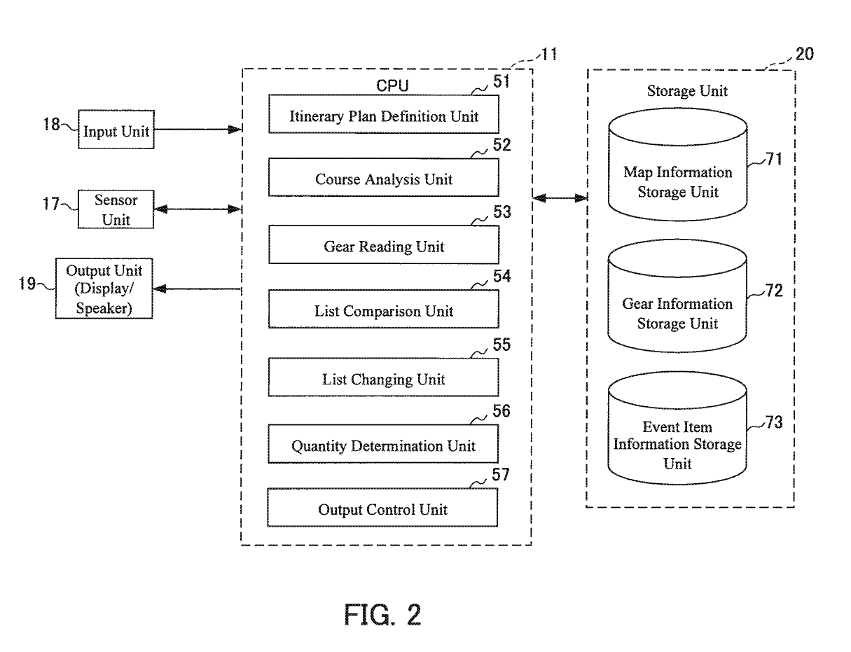

FIG. 2 is a functional block diagram showing the functional configuration for executing a gear list display processing, among the functional configurations of the map display device 1 shown in FIG. 1.

The gear list display processing is a series of processes of automatically selecting gear necessary for following the itinerary (finishing the itinerary) based on the itinerary plan being defined, making a list thereof, and then displaying.

When execution of the gear list display processing, as illustrated in FIG. 2, an itinerary plan definition unit 51, a course analysis unit 52, a gear reading unit 53, a list comparison unit 54, a list changing unit 55, a quantity determination unit 56 and an output control unit 57 operate in the CPU 11.

In addition, in a region in the storage unit 20, a map information storage unit 71, a gear information storage unit 72 and an event item information storage unit 73 are configured.

The map information storage unit 71 stores map information in association with advanced information. In addition, information on various events constituting a course such as facility, POI (Point of Interest), etc. are associated with the map information.

The gear information storage unit 72 stores gear information in which course types and gear are associated.

The event item information storage unit 73 stores mainly event item information in which event items and gear are associated.

The gear information and the event item information are described hereinafter.

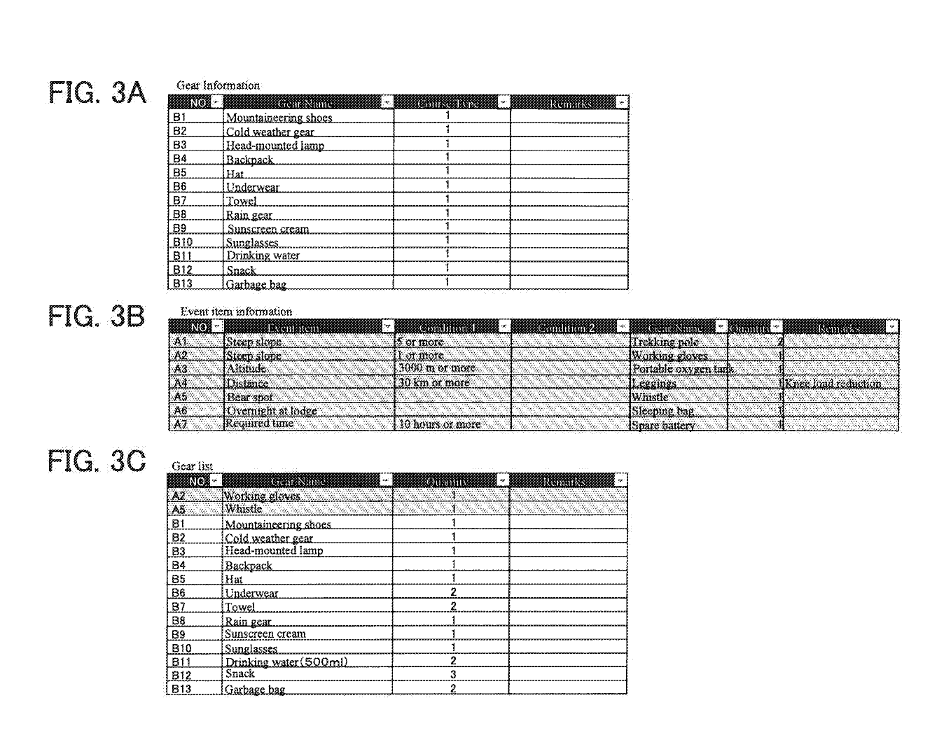

FIG. 3 is a schematic view for illustrating information relating to the gear list to be presented.

As illustrated in the example of FIG. 3A, in the gear information, “course type” and “remark” are associated with a “gear name” indicating the gear. To each item of the gear (“gear name”), a “number” is assigned for easily identifying each one.

Once the “course type” is determined based on a result of analysis of the defined course, gear corresponding to the “course type” are determined. More specifically, if a result of analysis indicates “course type: 1”, a plurality of gear “number: B1, mountaineering shoes” to “number: B13, waste bag” are determined. Thereafter, the gear thus determined is listed to thereby make a gear list.

In addition, the present embodiment is further configured to add gear corresponding to events within the course to the gear determined according to the course type. The event item information is used to identify gear corresponding to an event within the course.

As illustrated in the example of FIG. 3B, in the event item information associated are: “event item” indicating events within a course; “condition 1” and “condition 2” indicating conditions relating to the event; “gear name” indicating names of gear determined in a case in which the conditions relating to the event are satisfied; “quantity” indicating quantities of the gear; and “remark”. To each of the events (“event item”), a “number” is assigned for easily identifying each one.

When an event satisfying the conditions is found as a result of analysis of the defined course, gear corresponding to the “event item name” is determined. More specifically, as a result of the analysis, in a case in which there are at least 5 “steep slope” within the course, conditions “event item: steep slope, condition: at least 5” and “event item: steep slope, condition: at least 1” are satisfied, and “gear name: trekking pole, quantity: 2” and “gear name: working gloves, quantity: 1” are thus determined. Thereafter, the gear thus determined is listed to thereby make an event item list.

By comparing the gear list with the event item list, gear only on the event item list is added to the gear list, to thereby make a final gear list. As a result, a gear list as shown in the example of FIG. 3C is presented.

Referring back to FIG. 2, the itinerary plan definition unit 51 defines a course (route) and schedule as an itinerary plan. For example, in the case of mountaineering, a mountain trail course (route); information other than the mountain trail course, namely date and time of the mountaineering; and itinerary plan (mountaineering plan) including pass-through time of each point on the course, etc. are defined.

The course analysis unit 52 refers to the map information storage unit 71 and analyzes the course of the itinerary plan defined by the itinerary plan definition unit 51.

More specifically, the course analysis unit 52 analyzes the entire course and outputs an analysis result that allows determination of the course type. Information of the entire course, for example a total length of the course, a maximum inclination angle in the course, estimated required time for the course, etc. are analyzed.

Furthermore, the course analysis unit 52 analyzes events in the course constituting the course and outputs an analysis result that allows determination of the events in the course and conditions corresponding thereto. An event, which is a characteristic part of the course, is analyzed and gear considered necessary is output as an analysis result. For example, information on events in the itinerary plan, such as facilities along the course, routes constituting the course, altitude, areas of emergence of bears and wild animals (unique event along the course), overnight or not, required time for the course, etc. is analyzed.

The gear reading unit 53 reads relevant information from the gear information storage unit 72 and the event item information storage unit 73, based on the result of analysis by the course analysis unit 52.

More specifically, the gear reading unit 53 reads a list of gear corresponding to the course type (refer to FIG. 3A) as the gear list (refer to FIG. 3C) from the gear information storage unit 72, based on the result of analysis by the course analysis unit 52 allowing determination of the course type.

Furthermore, the gear reading unit 53 reads a list of gear corresponding to the conditions of the event item (refer to FIG. 3B) as the event item list from the event item information storage unit 73, based on the result of analysis by the course analysis unit 52 allowing determination of an event and conditions corresponding thereto.

The list comparison unit 54 makes a comparison between the gear list and the event item list which are read by the gear reading unit 53. This comparison shows gear which are on the event item list but not on the gear list.

Based on a result of the comparison between the gear list and the event item list by the list comparison unit 54, the list changing unit 55 makes a change to the gear list by adding gear which is on the event item list but not on the gear list (lacking gear) to the gear list.

Furthermore, the list changing unit 55 makes a change to the gear list in response to a gear list changing operation by a user via the input unit 18.

The quantity determination unit 56 determines the quantities of the gear based on the result of analysis by the course analysis unit 52.

More specifically, the quantity determination unit 56 calculates an amount of activity in the course, based on the result of analysis of the course, such as length, required time, etc., by the course analysis unit 52. Furthermore, the quantity determination unit 56 determines the quantity of consumable supplies such as foodstuff, water, etc. required for maintaining the activities to follow the itinerary, based on the required amount of activity thus calculated for the course. For example, the amount of activity can be calculated from physical activities and movement intensity (MET: metabolic equivalent of task); and the required quantity of foodstuff, water, etc. required for maintaining the activities to follow the itinerary can be determined from travel distance and travel time.

The output control unit 57 controls the output unit 19 to present the gear list.

More specifically, the output control unit 57 controls the output unit 19 to display the gear list including the quantities being determined. As a result, the gear list as shown in the example of FIG. 3C is displayed on the output unit 19.

Furthermore, the output control unit 57 determines whether or not a user has confirmed the current gear list.

In addition, the output control unit 57 controls the output unit 19 to display the gear list being finally determined. On this occasion, information on when and how each gear should be used during the itinerary can also be displayed.

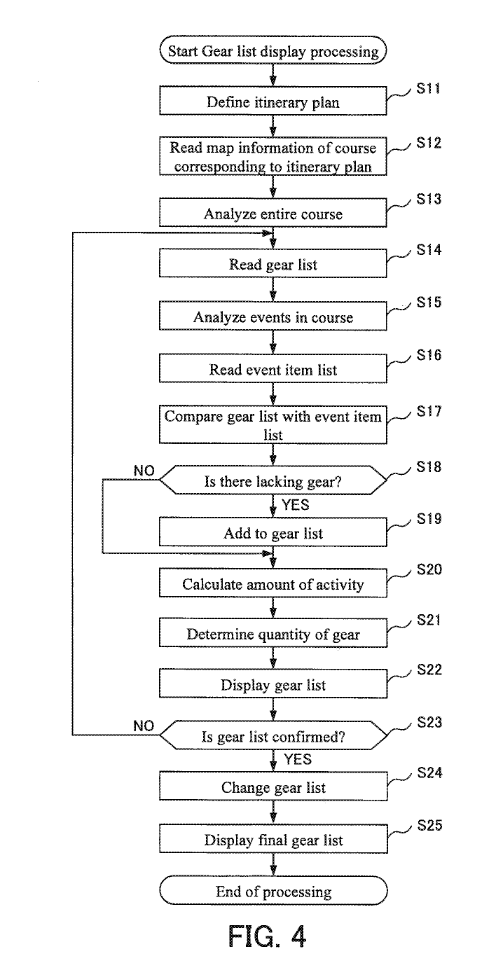

FIG. 4 is a flowchart illustrating the flow of the gear list display processing executed by the map display device of FIG. 1 having the functional configuration of FIG. 2.

The gear list display processing starts by a user's operation on the input unit 18 to start the gear list display processing.

In Step S11, in response to an itinerary plan defining operation by a user via the input unit 18, the itinerary plan definition unit 51 defines an itinerary plan including a course (route) that the user will take, date and time, etc.

In Step S12, the course analysis unit 52 reads from the map information storage unit 71 the map information of the course corresponding to the itinerary plan.

In Step S13, the course analysis unit 52 analyzes the map information of the entire course thus read corresponding to the itinerary plan. As a result, a total length of the course, a maximum inclination angle in the course (road state of the course), estimated required time for the course, etc. are analyzed to give a result allowing determination of the course type.

In Step S14, the gear reading unit 53 reads a gear list from the gear information storage unit 72, based on the result of analysis by the course analysis unit 52. More specifically, the gear reading unit 53 determines the course type based on a total length of the course, a maximum inclination angle in the course, estimated required time for the course, etc., and reads gear associated with the course type thus determined, as illustrated in FIG. 3A, as the gear list.

In Step S15, the course analysis unit 52 analyzes the events in the course, based on the map information of the course corresponding to the itinerary plan thus read. As a result, information on events in the itinerary plan, such as facilities along the course, routes constituting the course, altitude, overnight or not, etc. is analyzed to make it possible to determine events in the course and conditions corresponding to the events.

In Step S16, the gear reading unit 53 reads an event item list including events in the corresponding course from the event item information storage unit 73, based on the result of analysis by the course analysis unit 52. More specifically, the gear reading unit 53 determines events in the course and conditions corresponding to the events based on information on events in the itinerary plan, such as facilities along the course, routes constituting the course, altitude, overnight or not, etc. and reads the event item list including gear associated with the event items determined as illustrated in FIG. 3B.

In Step S17, the list comparison unit 54 compares the gear list which has been read in Step S14 with the event item list which has been read in Step S16.

As a result of the comparison, in Step S18, the list comparison unit 54 determines whether there are lacking gear that are on the event item list but not on the gear list.

In a case in which there is lacking gear, the determination in Step S18 is YES and the processing advances to Step S19.

On the contrary, in a case in which there is no lacking gear, the determination in Step S18 is NO and the processing advances to Step S20.

In Step S19, the list changing unit 55 adds the lacking gear to the gear list.

In Step S20, the quantity determination unit 56 calculates an amount of activity in the course, based on the result of analysis of the course, such as length, required time, etc. of the course.

In Step S21, the quantity determination unit 56 determines the quantity of consumable supplies such as foodstuff, water, etc. required for maintaining the activities to follow the itinerary, based on the amount of activity calculated for the course.

In Step S22, the output control unit 57 controls the output unit 19 to display the gear list including the quantities being determined.

In Step S23, the output control unit 57 determines whether or not a user has confirmed the current gear list.

In a case in which the current gear list is rejected, the determination in Step S23 is NO and the processing returns to Step S14.

On the contrary, in a case in which the current gear list is confirmed, the determination in Step S23 is YES and the processing advances to Step S24.

In Step S24, the list changing unit 55 makes a change to the gear list in response to the gear list changing operation by the user via the input unit 18. As a result, a gear list as shown in FIG. 3C is created.

In Step S25, the output control unit 57 controls the output unit 19 to display the gear list being finally determined. On this occasion, information on when and how each gear should be used during the itinerary can also be displayed. In addition, when presentation of the gear list, a capacity of a backpack or a bag required for holding the gear on the gear list can also be presented.

Thereafter, the gear list display processing is terminated.

### <Modification>

Further to the above described embodiment, in the case of the itinerary plan for a party of multiple members, gear for use by respective members and gear for use by the whole party are distributed based on the finally created gear list. This can avoid overlapping of gear for use by the whole party.

In addition, in a case in which a composition of the party is specified, it is possible to ask a user to input characteristics information (age, gender, physical strength and mountaineering experience, for example the number of times the member has progressed through the route) of each member constituting the party, to thereby allow distribution of the gear in such a way that bags for female members and children members (those who cannot bear heavy loads) are lighter and bags for male members (those who can bear heavy loads) are heavier, or that frame-generating equipment and edged tools that are likely to cause injury and therefore require special attention are not distributed to children members.

Although the present example is configured to create gear lists for a party of multiple members based on the gear list being finally determined, the present invention can also be configured to directly create such gear lists on the premise of a party of multiple members.

Although the above described embodiment is configured to create the gear list based on the information on the course, which is information on the entire course and the events in the course, the present invention can also be configured to create the gear list based on information that cannot be derived from the course information (information other than itinerary) as in the present example.

More specifically, the present invention can also be configured to create the gear list taking into consideration a total weight of loads, as well as conditions other than the course (e.g. weather on the day of progressing through/walking the defined course; season of, and time slot in, the day of progressing through/walking the defined course; the number of members progressing through/walking the defined course together; age, gender and nationality of the user and other members, etc.).

For example, in the case of considering the weather on the day of progressing through/walking the defined course and season of, and time slot in, the day of progressing through/walking the defined course, the present invention can be configured to make a change to the gear list according to temperature, rain, day or night, midnight and early morning, or a combination thereof.

In the case of considering the number of members, the present invention can be configured to make a change to the gear list according to distinction between a solo member and a party of members.

In the case of considering age, gender and nationality of the user and other members, the present invention can be configured to make a change to the gear list taking into consideration the different physical strengths, male and female bodily functions, religions and dietary habits. Alternatively, the present invention can be configured to make a change to the gear list according to a combination of the above examples.

In addition, corporeal information and physical strength information of a user can be input, and the gear list can be created based on the corporeal information and the physical strength information. The information to be input includes age, weight, height, gender, body fat percentage, muscle mass, muscle percentage, etc. The physical strength can be estimated based on frequency of exercises in everyday life and types of exercises being input. Such corporeal information and physical strength information of a user can be input, and the gear list is created based on the corporeal information and the physical strength information. For example in the case of the itinerary plan for a party of multiple members, a user with high muscle percentage and high muscle mass can be assumed to have superior physical strength and can be assigned a heavier load (total weight of his/her load is allowed to be heavier than those of other members of the party).

For example in the case of following a course such as a mountaineering course, preparation of gear, namely necessary equipment, is important for safely following the course. Furthermore, the load can be kept to a minimum by selecting necessary gear according to situations of the course such as geography and external environment. However, information on necessary gear such as equipment suggested in mountaineering literature, etc. is merely generalized information, and does not necessarily correspond to a specific course, such as a specific mountaineering route, to be followed. Selection of necessary gear such as equipment according to a course is not simple, and detailed information of the course and expert knowledge allowing analysis of the information are required. As a result, one may carry unnecessary gear such as equipment, or may realize lack of gear such as equipment on the go.

To address this, the map display device 1 of the present embodiment is configured to automatically select gear such as equipment according to situations such as geography of a course, allowing preparation of gear required for safety, while keeping the amount of gear to a minimum.

The map display device 1 configured as described above includes the itinerary plan definition unit 51, the gear reading unit 53, and the output unit 19.

The itinerary plan definition unit 51 defines a course.

The gear reading unit 53 identifies gear considered necessary when following the course, based on the information on the course selected by the itinerary plan definition unit 51.

The output unit 19 presents the gear considered necessary when following the course, identified by the gear reading unit 53.

As a result, the map display device 1 can automatically present gear which is appropriate to a planned course.

In addition, the itinerary plan definition unit 51 defines information other than the course (e.g., date and hour, weather, etc.).

The gear reading unit 53 identifies gear considered necessary when following the course, based on the information other than the course defined by the itinerary plan definition unit 51.

As a result, the map display device 1 can further automatically present gear based on information other than the course.

In addition, the map display device 1 includes the course analysis unit 52 that analyzes the information of the course selected by the itinerary plan definition unit 51.

The gear reading unit 53, based on a result of the analysis by the course analysis unit 52, identifies gear considered necessary when following the course for the whole course, and/or gear considered necessary when following the course for a partial event (event) in the course.

As a result, the map display device 1 can automatically present the gear considered necessary when following the course, for the entire course (itinerary) or for the events in the course, depending on the planned course.

The map display device 1 further includes the list comparison unit 54 that performs comparison in a case of identifying gear considered necessary when following the course for the whole course and gear considered necessary when following the course for events in the course.

The gear reading unit 53, based on a result of the comparison by the list comparison unit 54, among the gear considered necessary when following the course for the events in the course, identifies lacking gear that is not included in the gear considered necessary when following the course for the whole course.

As a result, the map display device 1 can identify the gear considered necessary when following the course, for the entire course or for the events in the course (itinerary), without shortage or excess.

The output unit 19 presents the lacking gear identified by the gear reading unit 53 as well as the gear considered necessary when following the course for the whole course, as gear considered necessary when following the course.

As a result, the map display device 1 can automatically present the gear considered necessary when following the course, for the entire course or for the events in the course (itinerary), without shortage or excess.

It should be noted that the present invention is not to be limited to the aforementioned embodiment, and that modifications, improvements, etc. within a scope that can achieve the objects of the present invention are included in the present invention.

The above described embodiment is configured to display and present the finally determined gear list to the user; however, the present invention can also be configured to submit the determined gear list to another device to thereby present the gear list on the another device. In addition, the present invention can be configured not only to display the finally determined gear list on the display (display unit) of the output unit 19, but also to output the finally determined gear list by sound from the speaker of the output unit 19. Furthermore, the present invention can be configured to print the finally determined gear list, by communicating with another device (e.g., printer) by way of the communication unit 21. A method of presentation can be changed according to external output means.

Moreover, as a manner of displaying the finally determined gear list (FIG. 3C) on the display unit of the output unit 19, the gear information corresponding to the course type (FIG. 3A) from the gear information storage unit 72 and the gear information corresponding to the conditions of the event item (FIG. 3B) from the event item information storage unit 73 can be displayed in different colors.

Additionally, the above described embodiment can be configured to, when the user is approaching an event or when the user has arrived at a location or timing of using the gear, send a notification for prompting the user to use the gear, or display such a notification on the output unit 19, based on information from the sensor unit 17.

The above described embodiment can also be configured to present a list of articles available on the go that can be alternative to some of the gear, for example water and foodstuffs available from on-site automatic vendors or shops, based on information obtained by analyzing the course.

The above described embodiment can also be configured to choose lighter/higher-performance gear according to courses, among various types of gear of the same function/usage. In the case of shoes, for a hiking trail, lighter sneakers can be chosen instead of heavyweight mountaineering shoes; and in the case of rain gear, for a hiking trail, a folding umbrella which is easier to use can be chosen instead of rainproof coat/jacket which is hands-free but is more cumbersome to use.

In addition, the above described embodiment can also be configured to have a difficulty level (for the user) of finishing the course set, and to present a gear list corresponding to the difficulty level. In the case of a high difficulty level being set, a gear list configured such that the user survives with on-site natural resources by combining the gear with the natural resources can be presented. For example, in the case of a high difficulty level being set, the gear list can be configured to include a filter for filtering water, fire-making tools for boiling and sterilizing the water, etc. instead of drinking water, to allow the user to obtain drinking water on the go. In the case of a low difficulty level being set, drinking water is included in the information of the gear list.

In addition, the above described embodiment can also be configured to have the gear list reviewed after execution of the plan, and update information by adding necessary gear thereto and removing unnecessary gear therefrom, for future use. The present invention can also be configured to learn gear lists previously created to improve accuracy of creation. In such a configuration, shortage and excess of gear can be prevented in the future.

Furthermore, in the above described embodiment, a gear list associated with a determined course type as shown in FIG. 3A is read from the gear information storage unit 72, based on the result of analysis by the course analysis unit 52; however, the gear list can be created by a user. The user creates a list of gear that he/she considers necessary (FIG. 3A), and then, according to a result of analysis of events in a course constituting the course, additional gear can be added thereto or the user can be informed of unnecessary gear therein.

Although the above described embodiment is configured to present a gear list corresponding to a course type, the present invention can also be configured to present a gear list corresponding to an individual course. In this case, if a selected course is similar to a course with gear being already determined, a gear list of the similar course can be presented to the selected course. Alternatively, a basic gear list can be presented regardless of course characteristics, and then gear corresponding to the course characteristics can be added thereto.

In the above described embodiment, the map display device 1, which is a smartphone, is configured as a single device; however, a device for creating gear lists (furthermore, a function of storing the map information from which information is obtained and a sensor function can be separate devices) and a device for display and notification of the gear list can be configured separately. In this case, the device for display and notification can be configured as a wrist-worn, watch-shaped device.

In addition, although map indication device 1 to which the present invention is applied is explained with the example of a smartphone in the aforementioned embodiment, it is not particularly limited thereto.

For example, the present invention can be applied to any electronic apparatus in general with an information processing function. More specifically, for example, the present invention can be applied to a laptop personal computer, a printer, a television receiver, a video camera, a portable navigation device, a cell phone device, a smartphone, a portable gaming device, and the like.

The aforementioned series of processing can be implemented by hardware, and can be implemented by software.

In other words, the functional configuration of FIG. 2 is merely an exemplification, and it is not particularly limited thereto. More specifically, it is sufficient so long as a function enabling the aforementioned series of processing to be executed as a whole to be equipped to the map display device 1, and what types of functional blocks are used in order to realize this function are not particularly limited to the example of FIG. 2.

In addition, one functional block may be configured by a unit of hardware, may be configured by a unit of software, or may be configured by a combination thereof.

In the case of having the series of processing executed by software, a program constituting this software is installed from a network or recording medium to a computer or the like.

The computer may be a computer built into dedicated hardware. In addition, the computer may be a computer capable of executing various functions by installing various programs, e.g., a general-purpose personal computer.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), a Blu-ray (registered trademark) disk (Blu-ray Disk) or the like. The magnetic optical disk is composed of an MD (Mini-Disk) or the like. The storage medium supplied to the user in a state incorporated in the device main body in advance may include, for example, the ROM 12 shown in FIG. 1, a hard disk included in the storage unit 20 shown in FIG. 1 or the like, in which the program is recorded.

It should be noted that, in the present specification, the steps defining the program recorded in the storage medium include not only the processing executed in a time series following this order, but also processing executed in parallel or individually, which is not necessarily executed in a time series.

Although some embodiments of the present invention have been described above, the embodiments are merely exemplifications, and are not to limit the technical scope of the present invention. Various other embodiments can be assumed for the present invention, and various modifications such as omissions and replacements are possible without departing from the spirit of the present invention. These embodiments or modifications thereof are within the scope and the spirit of the invention described in the present specification, and within the scope of the invention recited in the claims and equivalents thereof.

What is claimed is:

1. A presentation control method for a presentation device including a control unit, wherein the control unit:
identifies information on gear considered necessary for a user to carry when following a route, based on information on the route that the user will follow; and
outputs the information identified on the gear to an external output unit to present to the user.

2. The presentation method according to claim 1, wherein the control unit
outputs the information thus identified on the gear considered necessary when following the route to a display unit as the external output unit.

3. The presentation control method according to claim 1, wherein the control unit
analyzes the information on the defined route; and
identifies information on gear considered necessary when following the route for all states in the whole route, and/or information on gear considered necessary when following the route for a partial characteristic event in the route, based on a result of the analysis.

4. The presentation method according to claim 1, wherein the control unit
compares the information on gear considered necessary when following the route for all states in the whole route with the information on gear considered necessary when following the route for a partial event in the route; and
identifies information on lacking gear that is not included in the information on gear considered necessary when following the route for all states in the whole, route based on a result of the comparison, among the information on gear considered necessary when following the route for a partial event in the route.

5. The presentation method according to claim 4, wherein the control unit
outputs to the external output unit for presenting the information on lacking gear as well as the information on gear considered necessary when following the route for all states in the whole route as gear considered necessary when following the route.

6. The presentation method according to claim 3, wherein
the partial characteristic event in the route is a characteristic event including at least one of: a facility along the course; and a unique event along the course within an route defined by the user.

7. The presentation method according to claim 1, wherein the control unit
defines information other than the route; and
identifies gear considered necessary when following the route, based on the information other than the route.

8. The presentation method according to claim 7, wherein
the information other than the route is information including at least one of: weather of a scheduled day the user will follow the route; season of the scheduled day the user will follow the route; a period of time in the scheduled day the user will follow the route; the number of members following the route with the user on the scheduled day the user will follow the route; age and gender of the user; and age and gender of the members following the route with the user on the scheduled day the user will follow the route.

9. The presentation method according to claim 1, wherein the control unit
calculates an amount of activity consumed while progressing through the route; and
determines a quantity of the identified gear considered necessary when following the route, based on the amount of activity thus calculated.

10. The presentation method according to claim 1, wherein the control unit
distributes the identified gear considered necessary when following the route by the number of members progressing through the route together (with the user); and outputs to the external output unit for presenting data of the gear considered necessary when following the route, the data being distributed to each of the members progressing through the route.

11. The presentation method according to claim 10, wherein the control unit
changes a distribution destination of the gear according to characteristic information of each of the user and the members (progressing through the route together).

12. The presentation method according to claim 11, wherein
the characteristic information is information including at least one of: age and gender of the user; age and gender of members following the route with the user on the scheduled day the user will follow the route; physical strength of the user;
physical strength of the members following the route with the user on the scheduled day the user will follow the route; the number of times the user has progressed through the route; and
the number of times the members following the route with the user on the scheduled day the user will follow the route have progressed through the route.

13. The presentation method according to claim 1, wherein the control unit
outputs by sound the information thus identified on the gear considered necessary when following the route to a speaker as the external output unit.

14. A presentation device comprising a control unit, wherein the control unit is configured to:
define an route that a user will follow;
identify information on gear considered necessary for the user to carry when following the route, based on information on the route thus defined; and
output to present the information identified on the gear to an external output unit.

15. The presentation device according to claim 14, wherein:
the defining device includes a display unit as the external output unit; and
the control unit displays the information thus identified on the gear considered necessary when following the route to the display unit.

16. The presentation method according to claim 14, wherein the control unit:
analyzes the information on the defined route; and
identifies information on gear considered necessary when following the route for all states in the whole route, and/or information on gear considered necessary when following the route for a partial characteristic event in the route, based on a result of the analysis.

17. A computer-readable storage medium that controls a presentation device which includes a control unit, wherein the storage medium makes the presentation device execute:
a process of defining a route that a user will take;
a process of identifying information on gear considered necessary for the user to carry when following the route, based on information on the route thus defined; and
a process of outputting to present the information identified on the gear to an external output unit.

18. The computer-readable storage medium according to claim 17, comprising
a process of outputting the information thus identified on the gear considered necessary when following the route to a display unit as the external output unit.

19. The computer-readable storage medium according to claim 18, comprising
a process of analyzing the information on the defined route; and
a process of identifying information on gear considered necessary when following the route for all states in the whole route, and/or information on gear considered necessary when following the route for a partial characteristic event in the route, based on a result of the analysis.
